(19) United States
(12) Patent Application Publication
(10) Pub. No.: US 2005/0151744 A1
(43) Pub. Date: Jul. 14, 2005

(54) Method and apparatus for automated authoring and hyperlinking of VRML documents

(76) Inventor: Amit Chakraborty, Cranbury, NJ (US)

Correspondence Address: Siemens Corporation;Intellectual Property Department, 170 Wood Avenue South, Iselin, NJ, 08830, US

(21) Appl. No.: 10/755,148

(22) Filed: Jan. 9, 2004

(51) Int. Cl. G06T 1/00

(52) U.S. Cl. 345/501

(57) ABSTRACT

A method for automated authoring and hyperlinking of VRML (Virtual Reality Modeling Language) documents comprises inputting of a VRML file structured in Standard Generalized Markup Language (SGML); extracting a hierarchy of Anchorable Information Units (AIU's) from the VRML file; associating respective anchor nodes with each of the AIU'S to be hyperlinked; entering the respective anchor nodes into an AIU file utilizing VRML AIU specification language; and associating the AIU file with the VRML file.

The present invention relates generally to the field of creating, modifying, and editing of electronic documents and, more particularly, to the efficient and convenient application of such tasks, including the creation and association of hyperlinks, to VRML (Virtual Reality Modeling Language) documents.

### BACKGROUND OF THE INVENTION

Over the last several years, VRML (Virtual Reality Modeling Language) has gained wide acceptance, and has now emerged as the prime choice for describing platform-independent, interactive 3D objects and worlds. Currently several research groups are working towards the advancement of VRML and VRML-related technology.

VRML is a large and powerful scene description language. A primary objective in the development of the language was to serve the needs of users who wanted to use 3D graphics on the web. See “VRML: Browsing and Building Cyberspace”, Mark Pesce. New Riders Publishing, 1995.

VRML was and still is, to a large extent, based on the OpenInventor language developed by Silicon Graphics. However, it only uses a subset of the features of that more complex language, which is also part of the reason why it is so easy to use and manipulate. But the initial version, VRML 1.0 lacked interactivity and movement of any kind. To address some of these problems the current and widely used version, VRML 2.0/97 was developed, which provides which provides interactivity and mobility. See International Standard ISO/IEC IS 14722-1:1997.

It is herein recognized that several areas of improvement remain nevertheless, which have not been hitherto adequately addressed. Much of the current work by various research communities has gone towards addressing some of those shortcomings. For example, there have been attempts to provide a standardized way to save and restore the state of arbitrary VRML objects and worlds. See for example, “Transparent Access to and Encoding of VRML State Information” Martin Mauve, Proc. VRML 99, pp 29-38. It is herein recognized that the current specifications of the External Authoring Interface (EAI) and the script node API (Application Programming Interface) do not provide adequate functionality for state access and persistence. The work described in the afore-mentioned article in Proc. VRML 99 solves it by extending the EAI to allow content independent (transparent) saving and restoring of the VRML state.

Another shortcoming of VRML 97 herein recognized is its inability to support dynamic interactive multi-user worlds and shared visualizations. To that end, the article “Dynamic and Mobile VRML Gadgets,” B. Schonhage and A. Eliens, Proc. VRML 99, pp 47-52 discusses the use of CORBA and mobile object technology for the realization of VRML gadgets and VRML display agents that allow for updates in response to server-push events. In particular, a user can share a VRML world with another user simply by sending a clone of a display agent. This allows collaborative visualization to support decision making. Other researchers have addressed other aspects such as compression. See, for example, “A Compression/Decompression Method for Streaming based Humanoid Animation,” T. Naka et. al, Proc. VRML 99, pp 63-70.

However, while a majority of the researchers attach a lot of importance to interactivity, it is herein recognized that, relatively, not much effort has been made to extend the hyperlinking capabilities and especially to provide automated means of inserting hyperlinks in a systematic manner and to store them in a way that can be edited and changed easily.

Generally, the hypermedia authors have to locate Anchorable Information Units (AIU's) or “hotspots” (areas or keywords of particular significance) which are then appropriately hyperlinked to relevant information. In an electronic document, the user can thus retrieve associated detailed information by mouse clicking on these hotspots as the system interprets the associated hyperlinks and fetches the corresponding information.

This could be either a location within the same file or a text document or a video file or an audio clip. For instance, in the case of an industrial application, as an engineer navigates through a particular machine, once he finds the right part, he might need educational and service information regarding the repair of that part, which might be stored in the electronic manual as a combination of text documents (with images) and video clips.

It is herein recognized that these and several other areas for improvement remain which have not been adequately addressed so far. The creation of hypermedia, by and large, continues up to the present time to be a laborious, manually intensive job as is, in particular, the task of referencing content in drawing images to other media.

### BRIEF SUMMARY OF THE INVENTION

A crucial area for improvement is the need to be able to create automatic hyperlinks and change them without having to constantly edit the actual VRML files which are often very laborious to build. This is particularly true in view of the fact that effective and automated creation of hypermedia has recently been the focus of much attention due to the high demand for hypermedia applications generated as a result of the huge and growing popularity of the World Wide Web (WWW).

It is an object of the present invention to extend the hyperlinking capabilities and especially provide automated means of inserting hyperlinks in a systematic manner and to store them in a way that can be edited and changed easily.

In accordance with an aspect of the present invention, a method for automated authoring and hyperlinking of VRML documents utilizes Anchorable Information Units (AIUs) in a novel manner as a source of hyperlinks or hotspots in conjunction with VRML files. In accordance with the principles of the invention, a user need not change the actual contents of the VRML file. Instead a so-called AIU file is created that is associated along with the actual VRML file. This file, that has SGML (Standard Generalized Markup Language) syntax and grammar contains all the link information.

In accordance with another aspect of the present invention, this file is read and interpreted as and when the user interacts with the different objects of interest in the VRML file.

Another object of the present invention is to provide an easy mechanism for automatically creating and editing these links without actually having to edit the VRML file. Not only does this enhance the capability of electronic documents, but it also extends the functionality of the VRML world.

An appealing addition to the VRML 97 ISO standard is the support for motion and interactivity. See “The Virtual Reality Modeling Language, 1997” International Standard ISO/IEC IS 14722-1:1997. Objects can be modified, rotated and moved by the use of the interpolator nodes. In addition to this, VRML nodes respond to user interaction such as clicking and dragging by means of sensor nodes. Script nodes cover more complex actions and interactivity. The connection mechanisms between all of the above types of nodes are achieved using Routes which guide events from node to node, passing triggers and information through the scene.

It is another object of the present invention to provide a method that is complementary to the above-mentioned development involving nodes and scripts.

At this time, the only native capability that VRML has to create hyperlinks is through the use of anchors that really does not have the ability to interface with other programs except in a very cumbersome way. Further, to introduce such links one has to manually edit the VRML file.

In accordance with another aspect, the present invention makes it possible to use VRML within an environment that includes a host of other media types such as text, graphics, raster images, video, audio, etc. Such extension and added interactivity are essential to make the usage of VRML more practical across a wide variety of applications.

In accordance with another aspect of the present invention, VRML objects are stored using a novel specification language, hereinafter referred to as “VRML AIU” specification language that follows the SGML syntax.

In accordance with another aspect of the present invention, links are also coded using a link specification language that also follows the SGML syntax.

In accordance with another aspect of the present invention, the automatic hyperlinking is used to link VRML objects to different parts of a much larger media object such as a documentation system, whereby creating, maintaining, editing these links can be done in an automated fashion without having to change the VRML files.

In accordance with another aspect of the invention, method for automated authoring and hyperlinking of VRML documents, comprises inputting of a VRML file; extracting a hierarchy of nodes from the VRML file; identifying selected nodes of the hierarchy of nodes to be hyperlinked; associating respective anchor nodes with each of the selected nodes; entering the respective anchor nodes into an Anchorable Information Units (AIU) file; and associating the AIU file with the VRML file.

In accordance with another aspect of the invention, the step of entering the respective anchor nodes into an AIU file comprises entering the anchor nodes using a VRML AIU specification language.

In accordance with another aspect of the invention, the step of extracting a hierarchy of nodes from the VRML file comprises designating the nodes as being one of leaf and grouping nodes; and the step identifying selected nodes comprises identifying the grouping nodes as nodes to be hyperlinked.

In accordance with another aspect of the invention, the step of associating respective anchor nodes comprises associating the grouping nodes with the respective anchor nodes.

In accordance with another aspect of the invention, a method for automated authoring and hyperlinking of VRML documents, comprises inputting of a VRML file structured in Standard Generalized Markup Language (SGML); extracting a hierarchy of Anchorable Information Units (AIU's) from the VRML file; associating respective anchor nodes with each of the AIU'S to be hyperlinked; entering the respective anchor nodes into an AIU file utilizing VRML AIU specification language; and associating the AIU file with the VRML file.

In accordance with another aspect of the invention, a method for playback of VRML documents comprises loading a VRML file; determining whether there exists, in association with the VRML file, a respective AIU file incorporating anchor nodes relating to the VRML file and utilizing VRML AIU specification language and, if so, loading the AIU file; enabling a user to select a desired object of the VRML file; determining whether an AIU exists in the AIU file and, if so, indicating to the user that a link is available; and upon user selection of the link, executing link arguments in the AIU file.

In accordance with another aspect of the invention, a method for automated authoring, hyperlinking, and playback of VRML documents, comprises inputting of a VRML file structured in Standard Generalized Markup Language (SGML); extracting a hierarchy of Anchorable Information Units (AIU's) from the VRML file; associating respective anchor nodes with each of the AIU'S to be hyperlinked; entering the respective anchor nodes into an AIU file utilizing VRML AIU specification language; associating the AIU file with the VRML file; loading a further VRML file; determining whether there exists, in association with the further VRML file, a respective AIU file incorporating anchor nodes relating to the further VRML file and utilizing VRML AIU specification language and, if so, loading the AIU file; enabling a user to select a desired object of the VRML file; determining whether an AIU exists in the AIU file and, if so, indicating to the user that a link is available; and upon user selection of the link, executing link arguments in the AIU file.

In accordance with another aspect of the invention, a system for automated authoring and hyperlinking of VRML documents, comprises programmable computer apparatus for: inputting of a VRML file structured in Standard Generalized Markup Language (SGML); extracting a hierarchy of Anchorable Information Units (AIU's) from the VRML file; associating respective anchor nodes with each of the AIU'S to be hyperlinked; entering the respective anchor nodes into an AIU file utilizing VRML AIU specification language; and associating the AIU file with the VRML file.

In accordance with another aspect of the invention, a method for automated authoring and hyperlinking of VRML documents, comprises inputting of a VRML file structured in Standard Generalized Markup Language (SGML); extracting a hierarchy of Anchorable Information Units (AIU's) from the VRML file; associating respective anchor nodes with each of the AIU'S to be hyperlinked; entering the respective anchor nodes into an AIU file utilizing VRML AIU specification language; and associating the AIU file with the VRML file.

### BRIEF DESCRIPTION OF THE SEVERAL VIEWS OF THE DRAWINGS

These and other aspects of the invention will be more fully understood from the detailed description which follows, in conjunction with the Drawings, in which

FIG. 1 shows a flowchart of steps in accordance with the present invention;

FIG. 2 shows a flowchart of steps in the AIU Creation process in accordance with the present invention; and

FIG. 3 shows a flowchart of steps in the Playback process, in accordance with the present invention.

### DETAILED DESCRIPTION OF THE INVENTION

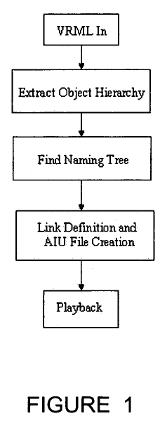

In accordance with a principle of the present invention, a user-friendly solution to the problem, herein recognized, of creating and playing hyperlinked VRML world is achieved by using a structured framework. The different objects in the VRML world are first organized in a structured tree-like manner suitable for manipulation and navigation within an object oriented framework such as XML/SGML, this step being hereinafter referred to as Extracting the Object Hierarchy. This leads to the “name tree,” (may also be referred to as a “naming tree”), i.e. a tree describing the names of the different objects that are part of the VRML world. One possibility is that there might be objects that initially do not have any names associated with them. In that case, names are associated that are relevant to the particular tree under consideration. Linking to other sections of the same or different VRML or to different other media forms is herein achieved using automated hyperlinking technology. Thus, if several links need to be made, one has the option of doing this automatically, rather than laboriously having to enter all of them manually as in the prior art. This is possible once again, because of the way of encoding all of this information using a structure in accordance with the invention. However, the option of manually defining these links remains available. During playback, on user interaction, the appropriate link is activated. FIG. 1 shows in schematic form a flow chart showing the main steps in the process, as will be more fully described below. The steps comprise the inputting of a VRML file, followed by a step of extracting the object hierarchy, and finding the name tree. This is followed by Link Definition and AIU File Creation, and Playback.

The first step, in accordance with the foregoing, is to be able to extract the object hierarchy and create the name tree. As will become clear in the following description, the more structure that is used while creating the VRML file, the better and more informative are the results of this process and the next. In other words if, for example, the objects were originally created in a tree fashion, this process extracts a tree that mimics the original tree. If instead, the objects were created as a group of independent trees, then the final outcome also has scant structure to it.

As will be understood, the input to the system is a VRML file. In accordance with the method of the present invention, we first go through the file and identify each one of the nodes. Then, for each one of them, we try to find out the type. There are two basic types of nodes in a VRML file: leaf and grouping. A leaf node is a terminating node in a tree. In between, there are nodes and sub-nodes and each node or sub-node is herein also referred to as an object. The leaf nodes often describe the basic shapes and the grouping nodes create the objects. For instance, for a chair, the leaf nodes might comprise a leg, a seat and a backrest. The grouping node organizes 4 legs, one seat and a backrest at a particular location and with different orientations to construct a chair at a particular location in a scene. Continuing with this example, it is desirable to give a unique name to each one of the chairs at the different locations and for their subparts. Furthermore, each one of them that needs to be hyperlinked is associated with an Anchor node with the unique name identifier. The Anchor node is needed because without it, VRML players would not allow the required interactivity.

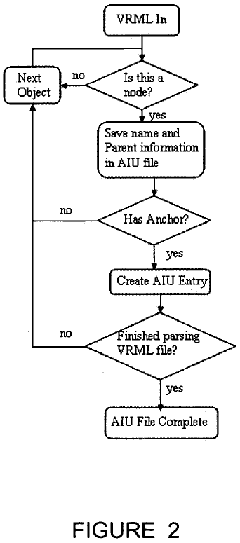

Thus, at the conclusion of this process, we have a root node that has several sub-nodes that in turn have their own sub-nodes and so on. Each one of the nodes has a unique name, and those that will be eventually hyperlinked have an anchor node associated with them. FIG. 2 shows a schematic flowchart showing steps in the AIU Creation process, in accordance with the present invention. The steps comprise the inputting of a VRML file, followed by a decision as to whether this represents a node. If not, the next object is entered and if yes, the system proceeds to save the name and parent information in the AIU file. A decision is then made as to whether the object has an Anchor. If not, the next object is entered and if yes, the system proceeds to create an AIU Entry. A decision is then made as to whether the system has finished parsing the VRML file. If not the next object is entered and if yes, the AIU file is complete.

The VRML AIU structure is next considered. In the method in accordance with the present invention, the structure of VRML documents is defined in SGML (Standard Generalized Markup Language) to capture the information extracted from VRML files. See ISO. SGML, IS08879:1986 Text and Office Systems-Standard Generalized Markup Language, 1986. The objects that are extracted from the VRML file are termed Anchorable Information Units (AIUs). A VRML document is thus represented as an instance of the VRML AIU Document Type Definition (DTD). Since a VRML document is well structured in SGML, it is then possible to perform automatic hyperlinking between VRML documents and essentially all other types of documents. This would be necessary so that when the user clicks on the object during navigation, the appropriate link can be navigated to reach the right destination.

After processing, each VRML file is associated with an AIU file, which contains all the relevant information extracted from the VRML file. The AIU file is defined in a hierarchical manner as follows:

At the root is the AIUDoc definition which encompasses the header, footer and the extracted information within the VRMLDocX field.

| | | | |
|---|---|---|---|
| <!ELEMENT | AIUDoc | --(DocHeader, | VRMLDocX, |
| DocFooter)> | | | |
| <!ATTLIST | AIUDoc | | |
| | Id | CDATA | #IMPLIED |
| | Type | CDATA | #IMPLIED |
| | Name | CDATA | #IMPLIED |
| > | | | |

The definition of the DocHeader is given as:

| <!ELEMENT | DocHeader | --(DocType, DocDesc)> | |
|---|---|---|---|
| <!ATTLIST | DocHeader | | |
| | Id | CDATA | #IMPLIED |
| | Type | CDATA | #IMPLIED |
| | Name | CDATA | #IMPLIED |
| | File | CDATA | #IMPLIED |
| > | | | |

and the fields in the VRMLDocX is given by (these fields will be defined below):

| <!ELEMENT | VRMLDocX | --((VRMLObject \| VRMLAIU)*)> | |
|---|---|---|---|
| <!ATTLIST | VRMLDocX | | |
| | Id | CDATA | #IMPLIED |
| | Desc | CDATA | #IMPLIED |
| > | | | |

The VRMLObjects fields are given by:

| <!ELEMENT | VRMLObject | --((#PCDATA)+) > | |
|---|---|---|---|
| <!ATTLIST | VRMLObject | | |
| | Id | CDATA | #IMPLIED |
| | Name | CDATA | #IMPLIED |
| | Parent | CDATA | #IMPLIED |
| > | | | |

Finally, the AIUs are defined using the following fields:

| <!ELEMENT | VRMLAIU | --((#PCDATA)+) > | |
|---|---|---|---|
| <!ATTLIST | VRMLAIU | | |
| | Id | CDATA | #IMPLIED |
| | Name | CDATA | #IMPLIED |
| | Parameter | CDATA | #IMPLIED |
| > | | | |

Thus an AIU file is a sequence of one or more parsable character data. Here it is clearly a string of ASCII characters. For more details on the SGML syntax refer to the afore-mentioned ISO. SGML, ISO8879:1986 Text and Office Systems-Standard Generalized Markup Language 1986. While most of the important attributes that are relevant to the VRML AIUs are listed above, there can be other optional attributes that are relevant for AIUs related to other media types. As mentioned before, the VRML document is structured in a hierarchical manner. At the root is the entire VRML world. This comprises different objects, which are in turn divided into sub-objects. The AIU file starts with a description of the type of the underlying media type, which in this case is VRML. The document header comprises four different fields comprises the underlying VRML file name, a unique Id for the whole VRML world, a document type definition, which explains the context of the VRML world and a more specific Document description explaining the content of the VRML file.

The information extracted from the VRML file is mostly stored within the VRMLDocX structure. It has a unique Id derived from the Id of the VRML file itself. Next, as previously mentioned, the VRML world is organized in a hierarchical manner. Once again, there is a unique Id for each object. The VRML AIUs also have a unique Id.

The following provides an example of a typical VRML AIU file. First the VRML file itself is shown and then the AIU file. The link definition is described in the following subsection.

```
#VRML V2.0 utf8
  DEF newbox Transform {
    rotation 1 0 0 0.4
    children Shape {
      appearance Appearance {
        material Material {
          diffuseColor 0.2 0.5 0.6
        } }
      geometry Box {
        size 20 0.1 10
      } } }
DEF newsphere Anchor {
Name “object1name”
parameter “object1parameter”
    children [
      Shape {
        appearance Appearance {
          material Material {
            diffuseColor 1 1 0
          }
        }
      geometry Sphere {
          radius 1.5
        }
        }
    ]
}
```

For this simple VRML file, the AIU file is as follows:

```
<AIUDoc>
<DocHeader Type=“VRML” File=“00049420.aiu”
ID=“N00049420”>
</DocHeader>
<VRMLDocX>
  <VRMLObject Name=”newbox” Parent=”root”>
  <VRMLObject Name=”newsphere” Parent=”root”>
  <VRMLAIU Name=“object1name” Type=“figure”>
    <Link Linkend=“figure PH c:♯atd♯atdmpdb Image15.gif
sysman”></Link>
  </VRMLAIU>
</VRMLDocX>
```

As is apparent, for this simple VRML world, there are two objects, one a box and the other a sphere, which has an AIU attached to it. When the user clicks on it, the player communicates with the link manager, which directs the OS to open up an image viewer to visualize an image stored at a particular location within an electronic book.

Next, hyperlinking VRML documents is considered. Hyperlinking for the VRML AIUs can either be done manually or in an automatic fashion. Manual links can be inserted during the AIU outlining phase as described before. However, in the approach in accordance with the present invention, since the information extracted from VRML is stored in well-structured AIU files, an Automatic Hyperlinker has been developed to automatically hyperlink VRML AIUs with essentially all other types of documents based on Hyperlink Specifications. That is, the Hyperlinker processes link specifications, performs pattern matching on the contents and structures of the documents, and establishes links between sources and destinations. Also important is how the link information encoded within the AIU files. Each one of the objects encoded can potentially have a link. Since the SGML structure has been adopted for our AIU files and links are entities within that file, Links are also defined using a similar SGML structure. The definition and the fields are given below:

| | | |
|---|---|---|
| <!ELEMENT | Link | --((#PCDATA)+) > |

| | | | |
|---|---|---|---|
| <!ATTLIST | Link | | |
| | LinkId | CDATA | #IMPLIED |
| | Type | CDATA | #IMPLIED |
| | SubType | CDATA | #IMPLIED |
| | Linkend | CDATA | #IMPLIED |
| | Book | CDATA | #IMPLIED |
| | Focus | CDATA | #IMPLIED |
| | LinkRuleId | CDATA | #IMPLIED |
| | ......... | | |
| > | | | |

The Type defines the type of the destination, i.e. if it is text or image or video, etc.

Focus defines the text that is highlighted at the link destination. Book represents the book of which the destination is part. Since a principal application herein is a hyperlinked manual, this is in turn organized as a hierarchical tree, where each manual is represented as a book. Linkend, the most important attribute, contains the destination information. LinkId is an index to the database if the destination points to that. LinkruleId indicates what rule created this link. SubType is similar to the Type definition in the AIU specification above. Labels give a description of the link destination. As usual, there can be other optional attributes as well.

First, the SGML documents (including the AIU files) are pre-indexed using a SGML Indexer in accordance with the present invention. This comprises a dictionary listing every SGML element in the order they appear in the documentation and an index into that dictionary. After this, based on the user-defined link specifications, links are created using pattern matching on these dictionary files. For the present VRML AIUs, links can be created to and from them in this way. Details about the hyperlinker can be found in “Towards Automating the Creation of Hypermedia service Manuals by compiling Specifications” Proc. IEEE Multimedia pp 203-212, 1991, but here a main point to be noted is that this machinery is able to be used within the present VRML AIU authoring system by being able to structure the VRML information using the AIU specification language as explained before. This also allows the use of the present hyperlink management systems that can incrementally update link rules. The link manager software that uses the link database to keep track of link rule changes by using time stamps does this. Incremental hyperlinking is done either by changing existing link specifications or by adding some extra link specifications. When adding new link specifications, the hyperlinker executes the new link specification on all documents, adds new links without destroying the old ones. When a link becomes obsolete, based on the Id of the old link, the old links are removed. A similar procedure is adopted when adding new links.

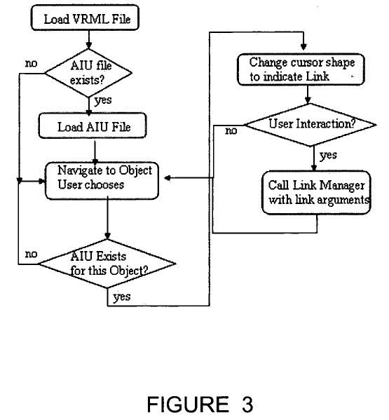

Next the hyperlinked VRML Player is considered. After the hyperlinking has been achieved, it is important to be able to get the desired functionality while in playback. The current implementation modifies a normal VRML player and uses special purpose software to achieve interprocess communication via the link manager. When the player is given a command to load a certain VRML file, while loading it, it also looks to see if an AIU file is available for that VRML file. If so, the AIU file is also loaded along with the original file. As the user navigates the VRML world, if there is a hyperlink associated with any structure, it is shown. Following this, if the user clicks on any of the objects, the player communicates with the link manager with the appropriate Link Id. The Link Manager then executes the link destination. Often within a multimedia documentation environment, this means jumping to a particular point of text or showing a detailed image of the object in question. In that case the SGML browser jumps to that point in the SGML document. A flowchart showing the different steps is shown in FIG. 3.

It will be understood that the present invention is intended to be practiced with the use of a programmable digital computer. The invention has been described by way of exemplary embodiments and it will be understood by one of skill in the art to which it pertains that various obvious changes and substitutions may be made without departing from the spirit of the invention, which is defined by the claims following.

1. A method for automated authoring and hyperlinking of VRML documents, comprising:
inputting of a VRML file;
extracting a hierarchy of nodes from said VRML file;
identifying selected nodes of said hierarchy of nodes to be hyperlinked;
associating respective anchor nodes with each of said selected nodes;
entering said respective anchor nodes into an Anchorable Information Units (AIU) file; and
associating said AIU file with said VRML file.

2. A method as recited in claim 1, wherein said step of entering said respective anchor nodes into an AIU file comprises entering said anchor nodes using a VRML AIU specification language.

3. A method as recited in claim 2, wherein
said step of extracting a hierarchy of nodes from said VRML file comprises designating said nodes as being one of leaf and grouping nodes; and
said step identifying selected nodes comprises identifying said grouping nodes as nodes to be hyperlinked.

4. A method as recited in claim 3, wherein said step of associating respective anchor nodes comprises associating said grouping nodes with said respective anchor nodes.

5. A method for automated authoring and hyperlinking of VRML documents, comprising:
inputting of a VRML file structured in Standard Generalized Markup Language (SGML);
extracting a hierarchy of Anchorable Information Units (AIU's) from said VRML file;
associating respective anchor nodes with each of said AIU'S to be hyperlinked;
entering said respective anchor nodes into an AIU file utilizing VRML AIU specification language; and
associating said AIU file with said VRML file.

6. A method as recited in claim 5, wherein said step of entering said respective anchor nodes into an AIU file utilizing VRML AIU specification language comprises a step of entering said respective anchor nodes into an AIU file comprising a header, footer and information on said anchor nodes within the VRMLDocX field.

7. A method for playback of VRML documents comprising:
loading a VRML file;
determining whether there exists, in association with said VRML file, a respective AIU file incorporating anchor nodes relating to said VRML file and utilizing VRML AIU specification language and, if so, loading said AIU file;
enabling a user to select a desired object of said VRML file;
determining whether an AIU exists in said AIU file and, if so, indicating to said user that a link is available; and
upon user selection of said link, executing link arguments in said AIU file.

8. A method for automated authoring, hyperlinking, and playback of VRML documents, comprising:
inputting of a VRML file structured in Standard Generalized Markup Language (SGML);
extracting a hierarchy of Anchorable Information Units (AIU's) from said VRML file;
associating respective anchor nodes with each of said AIU'S to be hyperlinked;
entering said respective anchor nodes into an AIU file utilizing VRML AIU specification language;
associating said AIU file with said VRML file;
loading a further VRML file;
determining whether there exists, in association with said further VRML file, a respective AIU file incorporating anchor nodes relating to said further VRML file and utilizing VRML AIU specification language and, if so, loading said AIU file;
enabling a user to select a desired object of said VRML file;
determining whether an AIU exists in said AIU file and, if so, indicating to said user that a link is available; and
upon user selection of said link, executing link arguments in said AIU file.

9. A system for automated authoring and hyperlinking of VRML documents, comprising programmable computer means for:
inputting of a VRML file structured in Standard Generalized Markup Language (SGML);
extracting a hierarchy of Anchorable Information Units (AIU's) from said VRML file;
associating respective anchor nodes with each of said AIU'S to be hyperlinked;
entering said respective anchor nodes into an AIU file utilizing VRML AIU specification language; and
associating said AIU file with said VRML file.

10. A system for automated authoring and hyperlinking, of VRML documents, comprising programmable computer means for:
inputting of a VRML file structured in Standard Generalized Markup Language (SGML);
extracting a hierarchy of Anchorable Information Units (AIU's) from said VRML file;
associating respective anchor nodes with each of said AIU'S to be hyperlinked;
entering said respective anchor nodes into an AIU file utilizing VRML AIU specification language;
associating said AIU file with said VRML file;
loading a further VRML file;
determining whether an associated AIU file exists and, if so, loading said AIU file;
enabling a user to select a desired object of said further VRML file;
determining whether an AIU exists in said AIU file and, if so, indicating to said user that a link is available; and
upon user selection of said link, executing link arguments in said AIU file.

11. A system as recited in claim 9, wherein said AIU file is defined as:

| | | | |
|---|---|---|---|
| <!ELEMENT | AIUDoc | --(DocHeader, | VRMLDocX, |
| DocFooter)> | | | |
| <!ATTLIST | AIUDoc | | |
| | Id | CDATA | #IMPLIED |
| | Type | CDATA | #IMPLIED |
| | Name | CDATA | #IMPLIED |
| > | | | |

said DocHeader being defined as:

| <!ELEMENT | DocHeader | --(DocType, DocDesc)> | |
|---|---|---|---|
| <!ATTLIST | DocHeader | | |
| | Id | CDATA | #IMPLIED |
| | Type | CDATA | #IMPLIED |
| | Name | CDATA | #IMPLIED |
| | File | CDATA | #IMPLIED |
| > | | | |

fields in the VRMLDocX being given by:

| <!ELEMENT | VRMLDocX | --((VRMLObject \| VRMLAIU)*)> | |
|---|---|---|---|
| <!ATTLIST | VRMLDocX | | |
| | Id | CDATA | #IMPLIED |
| | Desc | CDATA | #IMPLIED |
| > | | | |

VRMLObjects fields being given by:

| <!ELEMENT | VRMLObject | --((#PCDATA)+) > | |
|---|---|---|---|
| <!ATTLIST | VRMLObject | | |
| | Id | CDATA | #IMPLIED |
| | Name | CDATA | #IMPLIED |
| | Parent | CDATA | #IMPLIED |
| > | | | |

and AIUs being defined using the fields:

| <!ELEMENT | VRMLAIU | --((#PCDATA)+) > | |
|---|---|---|---|
| <!ATTLIST | VRMLAIU | | |
| | Id | CDATA | #IMPLIED |
| | Name | CDATA | #IMPLIED |
| | Parameter | CDATA | #IMPLIED |
| > | | | |

12. A system for playback of VRML documents comprising programmable computer means for:
loading a VRML file;
determining whether there exists, in association with said VRML file, a respective AIU file incorporating anchor nodes relating to said VRML documents and utilizing VRML AIU specification language and, if so, loading said AIU file;
enabling a user to select a desired object of said VRML file;
determining whether an AIU exists in said AIU file and, if so, indicating to said user that a link is available; and
upon user selection of said link, executing link arguments in said AIU file.

13. A system for playback of VRML documents comprising:
computer means for processing respective AIU files associated with said VRML documents, said AIU files incorporating anchor nodes relating to said VRML documents and utilizing VRML AIU specification language;
loading a VRML file;
determining whether an associated AIU file exists and, if so, loading said AIU file;
enabling a user to select a desired object of said VRML file;
determining whether an AIU exists in said AIU file and, if so, indicating to said user that a link is available; and
upon user selection of said link, executing link arguments in said AIU file.

14. A system as recited in claim 13, wherein said computer means for indicating to said user that a link is available comprises means for changing a cursor shape.
